(19) United States
(12) Patent Application Publication
(10) Pub. No.: US 2020/0026277 A1
(43) Pub. Date: Jan. 23, 2020

(54) AUTONOMOUS DRIVING DECISIONS AT INTERSECTIONS USING HIERARCHICAL OPTIONS MARKOV DECISION PROCESS

(71) Applicants: GM GLOBAL TECHNOLOGY OPERATIONS LLC, Detroit, MI (US); Carnegie Mellon University, Pittsburgh, PA (US)

(72) Inventors: Praveen Palanisamy, Sterling Heights, MI (US); Zhiqian Qiao, Pittsburgh, PA (US); Katharina Muelling, Pittsburgh, PA (US); John M. Dolan, Pittsburgh, PA (US); Upali P. Mudalige, Oakland Township, MI (US)

(73) Assignees: GM GLOBAL TECHNOLOGY OPERATIONS LLC, Detroit, MI (US); Carnegie Mellon University, Pittsburgh, PA (US)

(21) Appl. No.: 16/039,579

(22) Filed: Jul. 19, 2018

(51) Int. Cl. G05D 1/00; G06N 3/04; G06N 3/08; G05D 1/02

(52) U.S. Cl. CPC G05D 1/0088; G05D 1/0212; G06N 3/08; G06N 3/0472

(57) ABSTRACT

A method in an autonomous vehicle (AV) is provided. The method includes determining, from vehicle sensor data and road geometry data, a plurality of range measurements and obstacle velocity data; determining vehicle state data wherein the vehicle state data includes a velocity of the AV, a distance to a stop line, a distance to a midpoint of an intersection, and a distance to a goal; determining, based on the plurality of range measurements, the obstacle velocity data and the vehicle state data, a set of discrete behavior actions and a unique trajectory control action associated with each discrete behavior action; choosing a discrete behavior action and a unique trajectory control action to perform; and communicating a message to vehicle controls conveying the unique trajectory control action associated with the discrete behavior action.

### TECHNICAL FIELD

The present disclosure generally relates to autonomous vehicles, and more particularly relates to systems and methods for decision making in an autonomous vehicle at an intersection.

### BACKGROUND

An autonomous vehicle (AV) is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicles, such vehicles might still be improved in a number of respects. For example, the control algorithms in an autonomous vehicle may not be optimized for determining actions to take when an autonomous vehicle is at an intersection. As a further example, traversing a four-way intersection with two-way stop signs can be difficult for autonomous vehicles. Upon arrival, the vehicle needs to time its actions properly to make a turn onto the right-of-way road safely. If the vehicle enters the intersection too soon, it can result in a collision or cause the approaching right-of-way vehicles to brake hard. On the other hand, if the vehicle waits too long to make sure that it is safe for the vehicle to proceed, valuable time can be lost. It can be difficult for an autonomous vehicle to accurately estimate the time an approaching vehicle needs to reach and traverse an intersection and adjust the autonomous vehicle's decision when unexpected changes in the environment arise.

Accordingly, it is desirable to provide systems and methods for improving the decision process in an autonomous vehicle at an intersection. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided in an autonomous vehicle for deciding on actions to take at an intersection. In one embodiment, a processor-implemented method in an autonomous vehicle (AV) for executing a maneuver at an intersection is provided. The method includes determining, by a processor from vehicle sensor data and road geometry data, a plurality of range measurements wherein each range measurement is determined from a unique ray extending from a starting point on the AV to an ending point that is terminated by an obstacle in the path of that ray or a pre-determined maximum distance. The method further includes: determining, by the processor from vehicle sensor data, obstacle velocity data, wherein the obstacle velocity data includes a velocity of an obstacle determined to be at the ending point of the rays; determining, by the processor, vehicle state data, wherein the vehicle state data includes a velocity of the AV, a distance to a stop line, a distance to a midpoint of an intersection, and a distance to a goal; determining, by the processor based on the plurality of range measurements, the obstacle velocity data and the vehicle state data, a set of discrete behavior actions and a unique trajectory control action associated with each discrete behavior action; choosing, by the processor, a discrete behavior action from the set of discrete behavior actions and the associated unique trajectory control action to perform; and communicating, by the processor, a message to vehicle controls conveying the chosen unique trajectory control action associated with the discrete behavior action.

In one embodiment, the determining a plurality of range measurements and the determining obstacle velocity data includes: constructing a computer-generated virtual grid around the AV with the center of the virtual grid located at a middle front of the AV; dividing the virtual grid into a plurality of sub-grids; assigning an occupied characteristic to a sub-grid when an obstacle or moving object is present in the area represented by the sub-grid; tracing, through the virtual grid, a plurality of linear rays emitted from the middle front of the AV at a plurality of unique angles that covers the front of the AV, wherein each ray begins at the middle front of the AV and ends when it reaches an occupied sub-grid indicating an obstacle or a pre-determined distance; and determining, for each ray, the distance of that ray and the velocity of an obstacle at the end-point of that ray.

In one embodiment, the determining the set of discrete behavior actions and the unique trajectory control action associated with each discrete behavior action includes generating a state vector including the vehicle state data, the distance of each ray, and the velocity of obstacles at the end-points of the rays.

In one embodiment, the determining the set of discrete behavior actions and the unique trajectory control action associated with each discrete behavior action further includes applying the state vector as an input to a neural network configured to compute the set of discrete behavior actions and the unique trajectory control action associated with each discrete behavior action.

In one embodiment, the neural network includes: a hierarchical options network configured to produce two hierarchical option candidates, wherein the two hierarchical option candidates each include a trust option candidate and a do not trust option candidate; an actions network configured to produce lower level continuous action choices for acceleration and deceleration; and a Q values network configured to produce Q values corresponding to the lower level continuous action choices for acceleration and deceleration.

In one embodiment, the method further includes: deciding using the hierarchical option candidates that the AV can trust the environment; and deciding to implement the unique trajectory control action provided by the neural network.

In one embodiment, the neural network includes: a hierarchical options network wherein an input state vector sₜ is followed by three fully connected (FC) layers to generate a Q-values matrix Oₜ corresponding to two hierarchical option candidates; an actions network wherein the input state vector sₜ is followed by four FC layers to produce a continuous action vector aₜ; and a Q values network that receives the output of a concatenation of the input state vector sₜ followed by an FC layer with the continuous action vector aₜ followed by one FC layer, wherein the Q values network is configured to produce, through four FC layers, a Q-values vector Qₜ which corresponds to the action vector aₜ.

In one embodiment, the choosing a discrete behavior action and a unique trajectory control action to perform includes: modelling a choice of actions as a Markov Decision Process (MDP); learning an optimal policy via the neural network using reinforcement learning; and implementing the optimal policy to complete the maneuver at the intersection.

In one embodiment, the maneuver includes one of traversing straight through the intersection, turning left at the intersection, or turning right at the intersection.

In another embodiment, a system in an autonomous vehicle (AV) for executing a maneuver at an intersection is provided. The system includes an intersection maneuver module that includes one or more processors configured by programming instructions encoded in non-transient computer readable media. The intersection maneuver module is configured to: determine, from vehicle sensor data and road geometry data, a plurality of range measurements wherein each range measurement is determined from a unique ray extending from a starting point on the AV to an ending point that is terminated by an obstacle in the path of that ray or a pre-determined maximum distance; determine, from vehicle sensor data, obstacle velocity data wherein the obstacle velocity data includes a velocity of an obstacle determined to be at the ending point of the rays; determine vehicle state data wherein the vehicle state data includes a velocity of the AV, a distance to a stop line, a distance to a midpoint of an intersection, and a distance to a goal; determine, based on the plurality of range measurements, the obstacle velocity data and the vehicle state data, a set of discrete behavior actions and a unique trajectory control action associated with each discrete behavior action; choose a discrete behavior action from the set of discrete behavior actions and the associated unique trajectory control action to perform; and communicate a message to vehicle controls conveying the chosen unique trajectory control action associated with the discrete behavior action.

In one embodiment, the intersection maneuver module is configured to determine a plurality of range measurements and determine obstacle velocity data by: constructing a computer-generated virtual grid around the AV with a center of the virtual grid located at a middle front of the AV; dividing the virtual grid into a plurality of sub-grids; assigning an occupied characteristic to a sub-grid when an obstacle or moving object is present in the area represented by the sub-grid; tracing, through the virtual grid, a plurality of linear rays emitted from a middle front of the AV at a plurality of unique angles that covers the front of the AV, wherein each ray begins at the middle front of the AV and ends when it reaches an occupied sub-grid indicating an obstacle or a pre-determined distance; and determining, for each ray, the distance of that ray and the velocity of an obstacle at the end-point of that ray.

In one embodiment, the intersection maneuver module is configured to determine a set of discrete behavior actions and a unique trajectory control action associated with each discrete behavior action by generating a state vector including the vehicle state data, the distance of each ray, and the velocity of obstacles at the end-points of the rays.

In one embodiment, the intersection maneuver module is configured to determine a set of discrete behavior actions and a unique trajectory control action associated with each discrete behavior action by applying the state vector as an input to a neural network configured to compute the set of discrete behavior actions and the unique trajectory control action associated with each discrete behavior action.

In one embodiment, the neural network includes: a hierarchical options network configured to produce two hierarchical option candidates wherein the two hierarchical option candidates each include a trust option candidate and a do not trust option candidate; an actions network configured to produce lower level continuous action choices for acceleration and deceleration; and a Q values network configured to produce Q values corresponding to the lower level continuous action choices for acceleration and deceleration.

In one embodiment, the intersection maneuver module is further configured to: decide using the hierarchical option candidates that the AV can trust the environment; and decide to implement the unique trajectory control action provided by the neural network.

In one embodiment, the neural network includes: a hierarchical options network wherein an input state vector sₜ is followed by three fully connected (FC) layers to generate a Q-values matrix Oₜ corresponding to two hierarchical option candidates; an actions network wherein the input state vector sₜ is followed by four FC layers to produce a continuous action vector aₜ; and a Q values network that receives the output of a concatenation of the input state vector sₜ followed by an FC layer with the continuous action vector aₜ followed by one FC layer, wherein the Q values network is configured to produce, through four FC layers, a Q-values vector Qₜ which corresponds to the action vector aₜ.

In one embodiment, the intersection maneuver module is configured to choose a discrete behavior action and a unique trajectory control action to perform by: modelling a choice of actions as a Markov Decision Process (MDP); learning an optimal policy via the neural network using reinforcement learning; and implementing the optimal policy to complete the maneuver at the intersection.

In another embodiment, an autonomous vehicle (AV) is provided. The AV includes one or more sensing devices configured to generate vehicle sensor data and an intersection maneuver module. The intersection maneuver module is configured to: determine, from vehicle sensor data and road geometry data, a plurality of range measurements wherein each range measurement is determined from a unique ray extending from a starting point on the AV to an ending point that is terminated by an obstacle in the path of that ray or a pre-determined maximum distance; determine, from vehicle sensor data, obstacle velocity data wherein the obstacle velocity data includes a velocity of an obstacle determined to be at the ending point of the rays; determine vehicle state data wherein the vehicle state data includes a velocity of the AV, a distance to a stop line, a distance to a midpoint of an intersection, and a distance to a goal; determine, based on the plurality of range measurements, the obstacle velocity data and the vehicle state data, a set of discrete behavior actions and a unique trajectory control action associated with each discrete behavior action; choose a discrete behavior action from the set of discrete behavior actions and the associated unique trajectory control action to perform; and communicate a message to vehicle controls conveying the chosen unique trajectory control action associated with the discrete behavior action.

In one embodiment, the intersection maneuver module is configured to determine a plurality of range measurements and determine obstacle velocity data by: constructing a computer-generated virtual grid around the AV with a center of the virtual grid located at a middle front of the AV; dividing the virtual grid into a plurality of sub-grids; assigning an occupied characteristic to a sub-grid when an obstacle or moving object is present in the area represented by the sub-grid; tracing, through the virtual grid, a plurality of linear rays emitted from a middle front of the AV at a plurality of unique angles that covers the front of the AV, wherein each ray begins at the middle front of the AV and ends when it reaches an occupied sub-grid indicating an obstacle or a pre-determined distance; and determining, for each ray, the distance of that ray and the velocity of an obstacle at the end-point of that ray.

In one embodiment, the intersection maneuver module is configured to determine a set of discrete behavior actions and a unique trajectory control action associated with each discrete behavior action by: generating a state vector including the vehicle state data, the distance of each ray, and the velocity of obstacles at the end-points of the rays; and applying the state vector as an input to a neural network configured to compute the set of discrete behavior actions and the unique trajectory control action associated with each discrete behavior action. In the embodiment, the neural network includes: a hierarchical options network wherein an input state vector sₜ is followed by three fully connected (FC) layers to generate a Q-values matrix Oₜ corresponding to two hierarchical option candidates; an actions network wherein the input state vector sₜ is followed by four FC layers to produce a continuous action vector aₜ; and a Q values network that receives the output of a concatenation of the input state vector sₜ followed by an FC layer with the continuous action vector aₜ followed by one FC layer, wherein the Q values network is configured to produce, through four FC layers, a Q-values vector Qₜ which corresponds to the action vector aₜ.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle that includes an intersection maneuver module, in accordance with various embodiments;

FIG. 2 is functional block diagram illustrating an autonomous driving system (ADS) associated with an autonomous vehicle, in accordance with various embodiments;

FIG. 3 is a block diagram depicting an example intersection maneuver module in an example vehicle, in accordance with various embodiments;

FIG. 4 is a diagram depicting an example operation scenario which may be useful for an understanding of ray tracing, in accordance with various embodiments;

FIG. 5 is a process flow chart depicting an example process in a vehicle for choosing vehicle actions at an intersection, in accordance with various embodiments; and

FIG. 6 is a process flow chart depicting an example process for ray tracing when determining range measurements and the velocity of obstacles at the ending point of the rays used for range measurements, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

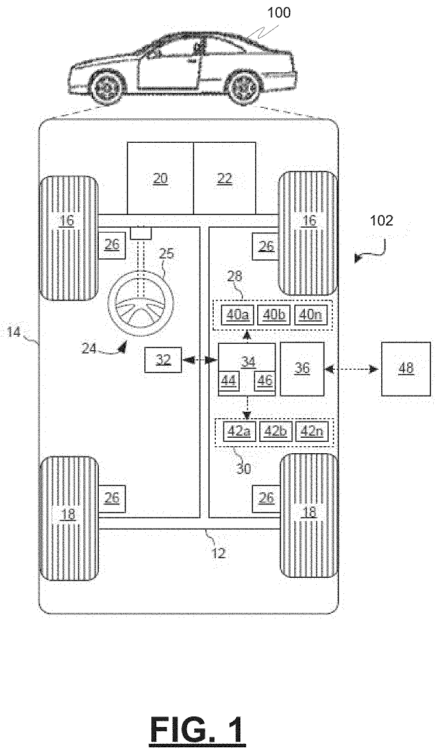

FIG. 1 depicts an example vehicle 100 with an intersection maneuver module shown generally as 102. In general, the intersection maneuver module 102 determines how the vehicle 100 should perform when reaching an intersection to allow vehicle controls to control the vehicle 100 to maneuver at the intersection.

The vehicle 100 generally includes a chassis 12, a body 14, front wheels 16, and rear wheels 18. The body 14 is arranged on the chassis 12 and substantially encloses components of the vehicle 100. The body 14 and the chassis 12 may jointly form a frame. The wheels 16-18 are each rotationally coupled to the chassis 12 near a respective corner of the body 14.

In various embodiments, the vehicle 100 is a vehicle capable of being driven autonomously or semi-autonomously, hereinafter referred to as an autonomous vehicle (AV). The AV 100 is, for example, a vehicle that can be automatically controlled to carry passengers from one location to another. The vehicle 100 is depicted in the illustrated embodiment as a passenger car, but other vehicle types, including motorcycles, trucks, sport utility vehicles (SUVs), recreational vehicles (RVs), marine vessels, aircraft, etc., may also be used.

As shown, the vehicle 100 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel. The steering system 24 is configured to receive control commands from the controller 34 such as steering angle or torque commands to cause the vehicle 100 to reach desired trajectory waypoints. The steering system 24 can, for example, be an electric power steering (EPS) system, or active front steering (AFS) system.

The sensor system 28 includes one or more sensing devices 40a-40n that sense observable conditions of the exterior environment and/or the interior environment of the vehicle 100 (such as the state of one or more occupants) and generate sensor data relating thereto. Sensing devices 40a-40n might include, but are not limited to, radars (e.g., long-range medium-range-short range), lidars, global positioning systems (GPS), optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26.

The data storage device 32 stores data for use in automatically controlling the vehicle 100. In various embodiments, the data storage device 32 stores defined maps of the navigable environment. In various embodiments, the defined maps may be predefined by and obtained from a remote system. For example, the defined maps may be assembled by the remote system and communicated to the vehicle 100 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 100. In various embodiments, controller 34 is configured to implement a mapping system as discussed in detail below.

The instructions may include one or more separate programs, each of which comprises an ordered listing of executable instructions for implementing logical functions. The instructions, when executed by the processor 44, receive and process signals (e.g., sensor data) from the sensor system 28, perform logic, calculations, methods and/or algorithms for automatically controlling the components of the vehicle 100, and generate control signals that are transmitted to the actuator system 30 to automatically control the components of the vehicle 100 based on the logic, calculations, methods, and/or algorithms. Although only one controller 34 is shown in FIG. 1, embodiments of the vehicle 100 may include any number of controllers 34 that communicate over any suitable communication medium or a combination of communication mediums and that cooperate to process the sensor signals, perform logic, calculations, methods, and/or algorithms, and generate control signals to automatically control features of the vehicle 100.

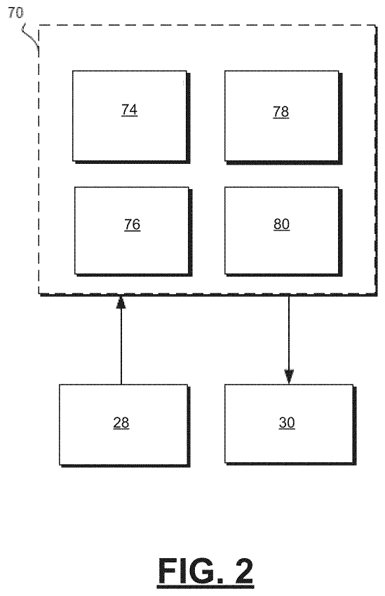

In accordance with various embodiments, controller 34 implements an autonomous or semi-autonomous driving system 70 as shown in FIG. 2. That is, suitable software and/or hardware components of controller 34 (e.g., processor 44 and computer-readable storage device 46) are utilized to provide an autonomous or semi-autonomous driving system 70.

In various embodiments, the instructions of the autonomous or semi-autonomous driving system 70 may be organized by function or system. For example, as shown in FIG. 2, the autonomous or semi-autonomous driving system 70 can include a perception system 74, a positioning system 76, a path planning system 78, and a vehicle control system 80. As can be appreciated, in various embodiments, the instructions may be organized into any number of systems (e.g., combined, further partitioned, etc.) as the disclosure is not limited to the present examples.

In various embodiments, the perception system 74 synthesizes and processes the acquired sensor data and predicts the presence, location, classification, and/or path of objects and features of the environment of the vehicle 100. In various embodiments, the perception system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 100 relative to the environment. As can be appreciated, a variety of techniques may be employed to accomplish this localization, including, for example, simultaneous localization and mapping (SLAM), particle filters, Kalman filters, Bayesian filters, and the like.

The path planning system 78 processes sensor data along with other data to determine a path for the vehicle 100 to follow. The vehicle control system 80 generates control signals for controlling the vehicle 100 according to the determined path.

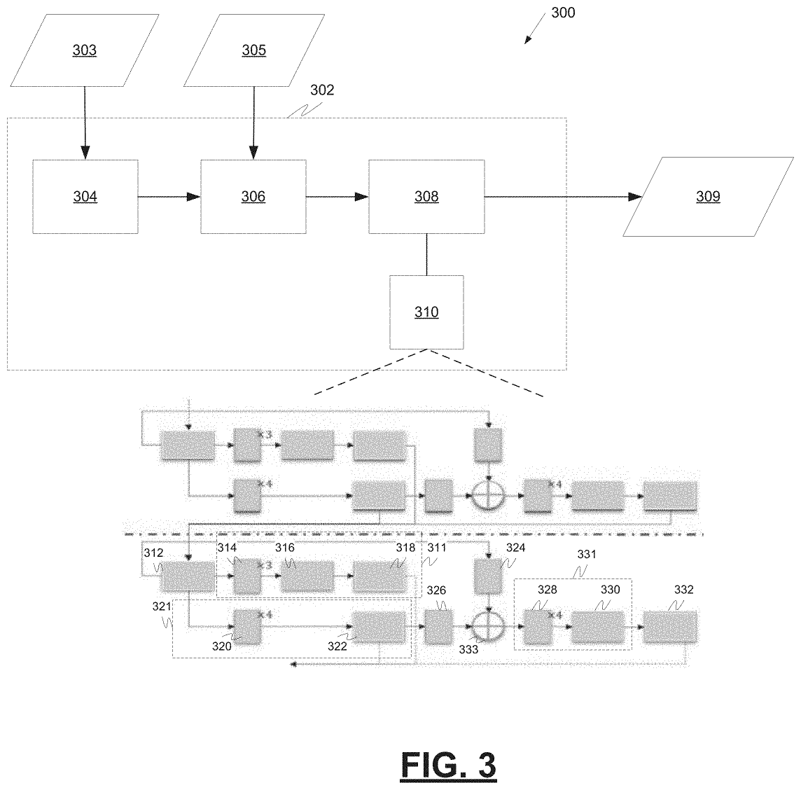

FIG. 3 is a block diagram depicting an example intersection maneuver module 302 (e.g., intersection maneuver module 102 of FIG. 1) in an example vehicle 300. The vehicle 300 may be an autonomously driven vehicle or a semi-autonomously driven vehicle. The example intersection maneuver module 302 is configured to model the decision-making process for the vehicle at an intersection as a Markov Decision Process (MDP) and provide a recommended higher-level maneuver and lower level action (e.g., acceleration or deceleration) to accomplish the recommended higher-level action. The maneuver may be one of traversing straight through the intersection, turning left at the intersection, or turning right at the intersection. The example intersection maneuver module 302 comprises one or more processors configured by programming instructions encoded on non-transient computer readable media. The example intersection maneuver module 302 includes a sensor data processor module 304, a state vector generation module 306, and a target acceleration generation module 308.

The example sensor data processor module 304 is configured to processes sensor data (e.g., lidar and/or radar) to obtain filtered range and velocity measurements (e.g., 61), 180 degrees (pi radians) in front of the vehicle 300, between the vehicle 300 and potential obstacles. The filtered range and velocity measurements are subsequently provided to the state vector generation module 306. The obstacles may include moving objects, such as another vehicle or a pedestrian. The obstacles may also include stationary objects or roadway boundaries. Using vehicle sensor data (e.g., lidar and/or radar) and road geometry data (e.g., map data), the example sensor data processor module 304 is configured to generate a plurality of range measurements wherein each range measurement is determined from a unique ray extending from a common starting point on the vehicle to an ending point that is terminated by one or more of an obstacle (e.g., another vehicle, roadway boundary, etc.) in the path of that ray or a pre-determined maximum distance. Each ray projects from the common starting point at a unique angle. Using vehicle sensor data 303 (e.g., lidar and/or radar), the example sensor data processor module 304 is further configured to determine obstacle velocity data wherein the obstacle velocity data comprises the velocity of obstacles at the ending points of the rays.

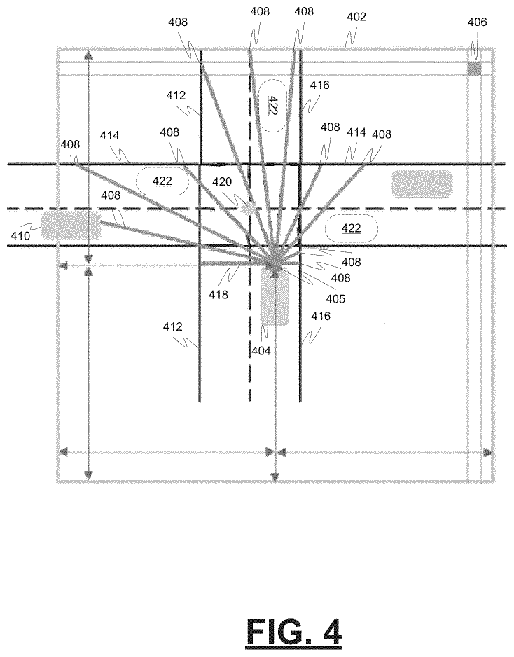

An example operation scenario which may be useful for an understanding of ray tracing is depicting in FIG. 4. To determine a plurality of range measurements and determine obstacle velocity data, the example sensor data processor module 304 is configured to construct a computer-generated virtual grid 402 around the autonomous vehicle 404. In this example, the virtual grid 402 is a square grid and has a size of 100 meters by 100 meters. The center 405 of the example virtual grid 402 is located at the middle front of the autonomous vehicle 404. The virtual grid 402 is subdivided into a large number (e.g., a million) sub-grids 406 (e.g., with size 0.1 meters by 0.1 meters).

The example sensor data processor module 304 is configured to assign a sub-grid 406 with an occupied characteristic when an obstacle or moving object is present in the physical area represented by the sub-grid 406. The example sensor data processor module 304 is configured to trace, through the virtual grid 402, a plurality of linear rays 408 (e.g., 61 ray traces) emitted from the front center of the AV 404 at a plurality of unique angles (e.g. spanning pi-radians) that covers the front of the vehicle 404, wherein each ray 408 begins at the middle front of the autonomous vehicle 404 and ends when it reaches an occupied sub-grid indicating an obstacle (e.g., moving vehicle 410, road boundary 412, 414, 416) or a pre-determined distance (e.g., 50 meters). The example sensor data processor module 304 is further configured to determine, for each ray 408, the distance of that ray 408 and the velocity of an obstacle (e.g., moving vehicle 410, road boundary 412, 414, 416) at the end-point of that ray 408.

The example state vector generation module 306 is configured to determine vehicle state data, wherein the vehicle state data includes a velocity (v) of the vehicle 404, a distance (d_{lb}) between the AV 404 and a stop line 418, a distance (dₘₚ) between the AV 404 and a midpoint 420 of an intersection, and a distance (d_{goal}) between the AV 404 and a goal location 422. The example state vector generation module 306 is configured to determine the vehicle state data using vehicle sensor data 303 (e.g., lidar and/or radar) and road geometry data (e.g., map data). The example state vector generation module 306 is configured to generate a state vector (sₜ) (e.g., a 126-D state vector) at a current time step, wherein sₜ=[v, d_{lb}, dₘₚ, d_{goal}, lᵢ, cᵢ] in which i ∈ [0, 60] and lᵢ and cᵢ, respectively, are the length lᵢ and the velocity cᵢ at the end point for each ray trace at the current time step.

In an example operating scenario, at each time step, a virtual grid 402 of size 100 m by 100 m is constructed whose center is the middle front of the AV 404. The virtual grid 402 is divided into a million sub-grids 406 with size 0.1 m×0.1 m. Each sub-grid 406 is occupied if there is any obstacle or moving object in this area. There are 61 ray traces 408 produced from the middle front of the AV 404 spanning pi radians (180 degrees) that cover the front view of the AV 404. Each ray 408 has a resolution of 0.5 meter and has a maximum reach of 50 meters. Each ray 408 is emitted from the front center of the AV 404 and if it reaches any obstacle like the road boundary 412 or a moving vehicle 410, the corresponding distance lᵢ and velocity cᵢ at the end point are sensed.

The example target acceleration generation module 308 is configured to determine, based on the plurality of range measurements, the obstacle velocity data and the vehicle state data, a set of higher level discrete behavior actions (e.g., left turn, right turn, straight through) and a unique trajectory control action (e.g., acceleration or deceleration level) associated with each higher level discrete behavior action. The example target acceleration generation module 308 is configured to use the state vector (sₜ) to determine a set of higher level discrete behavior actions and a unique trajectory control action associated with each higher level discrete behavior action. The example target acceleration generation module 308 comprises an artificial neural network (ANN) 310 configured to compute a set of higher level discrete behavior actions and a unique trajectory control action associated with each higher level discrete behavior action and is configured to determine a set of higher level discrete behavior actions and a unique trajectory control action associated with each higher level discrete behavior action by applying the state vector (sₜ) as an input to the ANN 310. Depicted are two instances of the ANN 310, one (310(t)) at a current time step t and a second (310(t−1)) at a prior time step t−1.

The example ANN 310 comprises a hierarchical options network 311 configured to produce two hierarchical option candidates comprising a trust option candidate and a do not trust option candidate. The example ANN 310 further comprises a low-level actions network 321 configured to produce lower level continuous action choices for acceleration and deceleration and a Q values network 331 configured to produce Q values corresponding to the lower level continuous action choices for acceleration and deceleration.

In the example hierarchical options network 311, an input state vector sₜ (312) is followed by three fully connected (FC) layers 314 to generate a Q-values matrix Oₜ (316) corresponding to two hierarchical option candidates (318) (e.g., go or no go). In the example low-level actions network 321, the input state vector sₜ (312) is followed by four FC layers (320) to produce a continuous action vector aₜ (322) (e.g., a 2-D continuous action vector including acceleration or deceleration rate data). The example Q values network 331 receives the output of a concatenation 333 of the input state vector sₜ (312) followed by an FC layer 324 with the continuous action vector aₜ (322) followed by one FC layer 326, and is configured to produce, through four FC layers 328, a Q-values vector Qₜ (330) which corresponds to the action vector 332.

The example ANN 310 may be trained using reinforcement learning algorithms such as the algorithms depicted below:

Algorithm 1 Main Process

| | |
|---|---|
| 1: | procedure HOMDP |
| 2: | Initialize two empty replay buffers Bₐ and Bₒ. |
| 3: | Initialize actor network NN^{a}, critic network NN^{Q} and option network NN^{O} with |
| | weights θ^{μ}, θ^{Q} and θ^{O} and the corresponding target actor network NN^{μ}^{^{t}}, critic net- |
| | work NN^{Q}^{^{t}} and option network NN^{O}^{^{t}} with weights θ^{μ}^{^{t}}, θ^{Q}^{^{t}} and θ^{O}^{^{t}}. |
| 4: | for e ← 1 to E epochs do |
| 5: | Get initial state s₀. Initial option is o₀ = SlowForward. rₒ = 0. |
| 6: | for t ← 1 to T time steps do |
| 7: | oₜ, aₜ = GetAction(sₜ, oₜ₋₁). sₜ₊₁, rₜ, done = StepForward(sₜ, oₜ, aₜ) |
| 8: | if oₜ is Forward then |
| 9: | rₒ + = rₜ and add (sₜ, oₜ, rₜ, sₜ₊₁, done) to Bₒ. |
| 10: | if done then |
| 11: | Add (sₜ, oₜ, rₒ, sₜ₊₁, done) to Bₒ. |
| 12: | else |
| 13: | Add (sₜ, oₜ, rₜ, sₜ₊₁, done) to Bₒ. |
| 14: | Sample random mini-batch of M transitions (sᵢ, oᵢ, rᵢ, sᵢ₊₁) from Bₒ and (sⱼ, |
| | aⱼ, rⱼ, sⱼ₊₁) from Bₐ. |
| 15: | oᵢ₊₁ = argmaxₒ O^{t}(sᵢ₊₁\|θ^{O}^{^{t}}). yᵢ^{o} = rᵢ + γ^{O}^{^{t}}(sᵢ₊₁\|θ^{O}^{^{t}}). |
| 16: | $Minimize {L}^{o} = \frac{1}{M} {\sum }_{i} {y}_{i}^{o} - O ( {s}_{i} \vert {θ}^{O} ) to update option network .$ |
| 17: | yⱼ^{μ} = rⱼ + γQ^{t}(sⱼ₊₁, aⱼ₊₁\|θ^{Q}^{^{t}}) |
| 18: | $Minimize {L}^{μ} = \frac{1}{M} {\sum }_{j} {y}_{j}^{μ} - Q ( {s}_{i} \vert {θ}^{Q} ) to update option network .$ |
| 19: | $\begin{matrix}\frac{1}{M} {\sum }_{j} {∇}_{μ ( {s}_{j} )} Q ( {s}_{j} , μ ( {s}_{j} ) \vert {θ}^{Q} ) {∇}_{{θ}^{μ}} μ ( {s}_{j} \vert {θ}^{μ} ) is the policy gradient and is \\ used to update actor network .\end{matrix}$ |
| 20: | Update the target networks: θ^{z}^{^{t}} ← rθ^{z} + (1 − r)θ^{z}^{^{t}} for z in {μ, Q, O}. |

Algorithm 2 Get Action

| | |
|---|---|
| 1: | procedure GETACTION(s, o) |
| 2: | if o is SlowForward then |
| 3: | o ← arg maxₒ O^{t}(s\|θ ^{o}_{^{t}}) according to ε greedy. |
| 4: | a = 0. |
| 5: | if o is Forward then |
| 6: | a = μ(s\|θ ^{μ})+ N where N is a random |
| | process. |

Algorithm 3 Move one Step Forward

| | |
|---|---|
| 1: | procedure STEPFORWARD(s, o, a) |
| 2: | if o is SlowForward then |
| 3: | Slowly move forward with d meters and stop. |
| 4: | $else if Any \frac{\text{?}}{{w}_{i}} \leq a then$ |
| 5: | Decrease speed of ego car with deceleration c_{d}. |
| 6: | else |
| 7: | Increase velocity of ego car with acceleration cₐ. |

$\text{?} \text{indicates text missing or illegible when filed}$

The example target acceleration generation module 308 is further configured to choose a higher level discrete behavior action and a unique trajectory control action to perform at an intersection and to make the choice by modelling the process of choosing actions as a Markov Decision Process (MDP). The example target acceleration generation module 308 is configured to decide using the hierarchical option candidates that the AV vehicle can trust the environment and decide to implement the unique trajectory control action (e.g., acceleration or deceleration) provided by the ANN 310. The example target acceleration generation module 308 is configured to learn an optimal policy via the ANN 310 using reinforcement learning and configured to implement the optimal policy to complete a maneuver at the intersection. To implement the optimal policy to complete a maneuver at the intersection, the example intersection maneuver module 302 is further configured to communicate a message 309 to vehicle controls conveying the unique trajectory control action associated with the higher level discrete behavior action.

An example intersection maneuver module 302 may include any number of additional sub-modules embedded within the controller 34 which may be combined and/or further partitioned to similarly implement systems and methods described herein. Additionally, inputs to the intersection maneuver module 302 may be received from the sensor system 28, received from other control modules (not shown) associated with the vehicle 100, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

The various modules described above may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.

In some embodiments, training of any machine learning models used by intersection maneuver module 302 occurs within a system remote from vehicle 300 and is subsequently downloaded to vehicle 300 for use during normal operation of vehicle 300. In other embodiments, training occurs at least in part within controller 34 of vehicle 300, itself, and the model is subsequently shared with external systems and/or other vehicles in a fleet. Training data may similarly be generated by vehicle 300 or acquired externally, and may be partitioned into training sets, validation sets, and test sets prior to training.

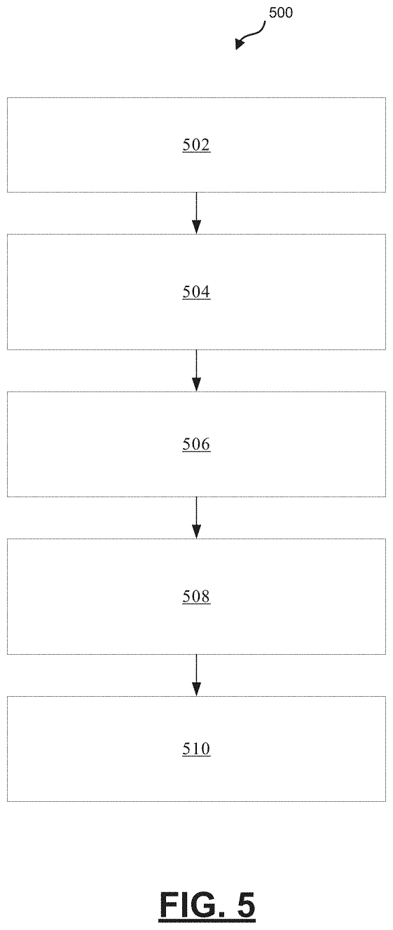

FIG. 5 is a process flow chart depicting an example process 500 in a vehicle for choosing vehicle actions at an intersection. The order of operation within the example process 500 is not limited to the sequential execution as illustrated in the figure, but may be performed in one or more varying orders as applicable and in accordance with the present disclosure.

The example process 500 includes determining, from vehicle sensor data and road geometry data, a plurality of range measurements and the velocity of obstacles at the ending point of the range measurements (operation 502). Each range measurement is determined from a unique ray extending at a unique angle from a common starting point on the vehicle to an ending point that is terminated by one or more of an obstacle (e.g., another vehicle, roadway boundary, etc.) in the path of that ray or a pre-determined maximum distance.

The example process 500 further includes determining vehicle state data (operation 504). The vehicle state data includes a velocity of the vehicle, a distance to a stop line, a distance to a midpoint of an intersection, and a distance to a goal.

The example process 500 further includes determining a set of higher level discrete behavior actions (e.g., left turn, right turn, straight through) and a unique trajectory control action (e.g., acceleration or deceleration level) associated with each higher level discrete behavior action (operation 506). The determining is performed using the plurality of range measurements, the obstacle velocity data and the vehicle state data. The determining may be performed using a state vector (e.g., 126-D state vector) including the vehicle state data (e.g., velocity of the vehicle, a distance to a stop line, a distance to a midpoint of an intersection, and a distance to a goal), the distance of each ray, and the velocity of an obstacle at the end-point of that ray. The determining may be performed by applying the state vector as an input to a neural network configured to compute a set of higher level discrete behavior actions and a unique trajectory control action associated with each higher level discrete behavior action.

The neural network may include a hierarchical options network configured to produce two hierarchical option candidates wherein the hierarchical option candidates include a trust option candidate and a do not trust option candidate; a low-level actions network configured to produce lower level continuous action choices for acceleration and deceleration; and a Q values network configured to produce Q values corresponding to the lower level continuous action choices for acceleration and deceleration. The neural network may include a hierarchical options network wherein an input state vector sₜ (e.g., a 126-D input state vector) is followed by three fully connected (FC) layers to generate a Q-values matrix Oₜ (e.g., a 2-D Q-values matrix) corresponding to two hierarchical option candidates (e.g., go or no go); a low-level actions network wherein the input state vector sₜ is followed by four FC layers to produce a continuous action vector aₜ (e.g., a 2-D continuous action vector including acceleration or deceleration rate data); and a Q values network that receives the output of a concatenation of the input state vector followed by an FC layer with the continuous action vector aₜ followed by one FC layer, wherein the Q values network is configured to produce, through four FC layers, a Q-values vector Qₜ which corresponds to the action vector.

The example process 500 further includes choosing a higher level discrete behavior action and a unique trajectory control action to perform (operation 508). The choosing may be performed by modelling the process of choosing a maneuver to attempt at an intersection as a Markov Decision Process (MDP), learning an optimal policy via the neural network using reinforcement learning, and implementing the optimal policy to complete the maneuver at the intersection.

The example process 500 further includes communicating a message to vehicle controls conveying the unique trajectory control action associated with the higher level discrete behavior action (operation 510). Vehicle controls may implement the communicated trajectory control action to perform a maneuver at an intersection.

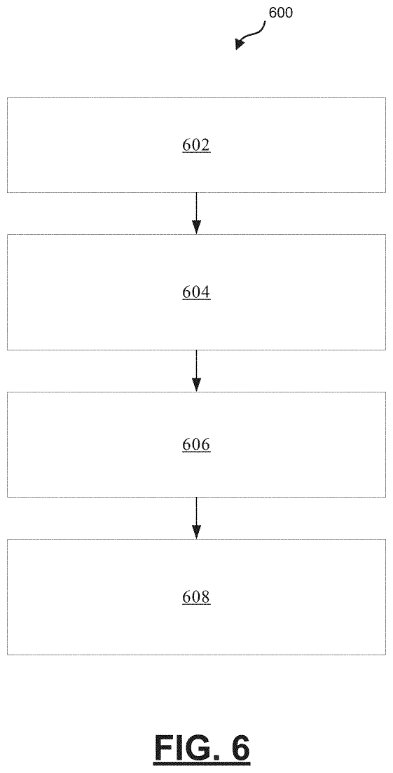

FIG. 6 is a process flow chart depicting an example process 600 for ray tracing when determining range measurements and the velocity of obstacles at the ending point of the rays used for range measurements. The order of operation within the example process 600 is not limited to the sequential execution as illustrated in the figure, but may be performed in one or more varying orders as applicable and in accordance with the present disclosure.

The example process 600 includes constructing a computer-generated virtual grid (e.g., a square grid) around the autonomous vehicle (e.g., of size 100 meters by 100 meters) with the center of the virtual grid located at the middle front of the autonomous vehicle (operation 602). The example process 600 includes sub-dividing the virtual grid into a large number (e.g., a million) of sub-grids (e.g., with size 0.1 meters by 0.1 meters) (operation 604). The example process 600 includes assigning an occupied characteristic to a sub-grid when an obstacle or moving object is present in the area represented by the sub-grid (operation 606).

The example process 600 further includes tracing, through the virtual grid, a plurality of linear rays (operation 608). The plurality of linear rays (e.g., 61 ray traces), in the example process, are emitted from the front center of the AV at a plurality of unique angles (e.g. spanning pi-radians) that covers the front of the vehicle, wherein each ray begins at the middle front of the autonomous vehicle and ends when it reaches an occupied sub-grid indicating an obstacle (e.g., moving vehicle, road boundary) or a pre-determined distance (e.g., 50 meters). The ray tracing involves determining, for each ray, the distance of that ray and the velocity of an obstacle at the end-point of that ray.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof.

What is claimed is:

1. A processor-implemented method in an autonomous vehicle (AV) for executing a maneuver at an intersection, the method comprising:
determining, by a processor from vehicle sensor data and road geometry data, a plurality of range measurements, each range measurement determined from a unique ray extending from a starting point on the AV to an ending point that is terminated by an obstacle in the path of that ray or a pre-determined maximum distance;
determining, by the processor from vehicle sensor data, obstacle velocity data, wherein the obstacle velocity data comprises a velocity of an obstacle determined to be at the ending point of the rays;
determining, by the processor, vehicle state data, the vehicle state data including a velocity of the AV, a distance to a stop line, a distance to a midpoint of an intersection, and a distance to a goal;
determining, by the processor based on the plurality of range measurements, the obstacle velocity data and the vehicle state data, a set of discrete behavior actions and a unique trajectory control action associated with each discrete behavior action;
choosing, by the processor, a discrete behavior action from the set of discrete behavior actions and the associated unique trajectory control action to perform; and
communicating, by the processor, a message to vehicle controls conveying the chosen unique trajectory control action associated with the discrete behavior action.

2. The method of claim 1, wherein the determining a plurality of range measurements and the determining obstacle velocity data comprises:
constructing a computer-generated virtual grid around the AV with the center of the virtual grid located at a middle front of the AV;
dividing the virtual grid into a plurality of sub-grids;
assigning an occupied characteristic to a sub-grid when an obstacle or moving object is present in the area represented by the sub-grid;
tracing, through the virtual grid, a plurality of linear rays emitted from the middle front of the AV at a plurality of unique angles that covers a front of the AV, wherein each ray begins at the middle front of the AV and ends when it reaches an occupied sub-grid indicating an obstacle or a pre-determined distance; and
determining, for each ray, the distance of that ray and the velocity of an obstacle at the end-point of that ray.

3. The method of claim 1, wherein the determining the set of discrete behavior actions and the unique trajectory control action associated with each discrete behavior action comprises:
generating a state vector including the vehicle state data, the distance of each ray, and the velocity of obstacles at the end-points of the rays.

4. The method of claim 3, wherein the determining the set of discrete behavior actions and the unique trajectory control action associated with each discrete behavior action further comprises:
applying the state vector as an input to a neural network configured to compute a set of discrete behavior actions and the unique trajectory control action associated with each discrete behavior action.

5. The method of claim 4, wherein the neural network comprises:
a hierarchical options network configured to produce two hierarchical option candidates, the two hierarchical option candidates each including a trust option candidate and a do not trust option candidate;
an actions network configured to produce lower level continuous action choices for acceleration and deceleration; and
a Q values network configured to produce Q values corresponding to the lower level continuous action choices for acceleration and deceleration.

6. The method of claim 5, further comprising:
deciding using the hierarchical option candidates that the AV can trust the environment; and
deciding to implement the unique trajectory control action provided by the neural network.

7. The method of claim 4, wherein the neural network comprises:
a hierarchical options network wherein an input state vector sₜ is followed by three fully connected (FC) layers to generate a Q-values matrix Oₜ corresponding to two hierarchical option candidates;
an actions network wherein the input state vector sₜ is followed by four FC layers to produce a continuous action vector aₜ; and
a Q values network that receives the output of a concatenation of the input state vector sₜ followed by an FC layer with the continuous action vector aₜ followed by one FC layer, wherein the Q values network is configured to produce, through four FC layers, a Q-values vector Qₜ which corresponds to the action vector aₜ.

8. The method of claim 7, wherein the choosing a discrete behavior action and a unique trajectory control action to perform comprises:
modelling a choice of actions as a Markov Decision Process (MDP);
learning an optimal policy via the neural network using reinforcement learning; and
implementing the optimal policy to complete the maneuver at the intersection.

9. The method of claim 1, wherein the maneuver comprises one of traversing straight through the intersection, turning left at the intersection, or turning right at the intersection.

10. A system in an autonomous vehicle (AV) for executing a maneuver at an intersection, the system comprising an intersection maneuver module that comprises one or more processors configured by programming instructions encoded in non-transient computer readable media, the intersection maneuver module configured to:
determine, from vehicle sensor data and road geometry data, a plurality of range measurements, each range measurement determined from a unique ray extending from a starting point on the AV to an ending point that is terminated by an obstacle in the path of that ray or a pre-determined maximum distance;
determine, from vehicle sensor data, obstacle velocity data, wherein the obstacle velocity data comprises a velocity of an obstacle determined to be at the ending point of the rays;
determine vehicle state data wherein the vehicle state data includes a velocity of the AV, a distance to a stop line, a distance to a midpoint of an intersection, and a distance to a goal;
determine, based on the plurality of range measurements, the obstacle velocity data and the vehicle state data, a set of discrete behavior actions and a unique trajectory control action associated with each discrete behavior action;
choose a discrete behavior action from the set of discrete behavior actions and the associated unique trajectory control action to perform; and
communicate a message to vehicle controls conveying the chosen unique trajectory control action associated with the discrete behavior action.

11. The system of claim 10, wherein the intersection maneuver module is configured to determine a plurality of range measurements and determine obstacle velocity data by:
constructing a computer-generated virtual grid around the AV with the center of the virtual grid located at a middle front of the AV;
dividing the virtual grid into a plurality of sub-grids;
assigning an occupied characteristic to a sub-grid when an obstacle or moving object is present in the area represented by the sub-grid;
tracing, through the virtual grid, a plurality of linear rays emitted from the middle front of the AV at a plurality of unique angles that covers a front of the AV, wherein each ray begins at the middle front of the AV and ends when it reaches an occupied sub-grid indicating an obstacle or a pre-determined distance; and
determining, for each ray, the distance of that ray and the velocity of an obstacle at the end-point of that ray.

12. The system of claim 10, wherein the intersection maneuver module is configured to determine a set of discrete behavior actions and a unique trajectory control action associated with each discrete behavior action by:
generating a state vector including the vehicle state data, the distance of each ray, and the velocity of obstacles at the end-points of the rays.

13. The system of claim 12, wherein the intersection maneuver module is configured to determine the set of discrete behavior actions and the unique trajectory control action associated with each discrete behavior action by:
applying the state vector as an input to a neural network configured to compute the set of discrete behavior actions and the unique trajectory control action associated with each discrete behavior action.

14. The system of claim 13, wherein the neural network comprises:
a hierarchical options network configured to produce two hierarchical option candidates, the two hierarchical option candidates each including a trust option candidate and a do not trust option candidate;
an actions network configured to produce lower level continuous action choices for acceleration and deceleration; and
a Q values network configured to produce Q values corresponding to the lower level continuous action choices for acceleration and deceleration.

15. The system of claim 14, wherein the intersection maneuver module is further configured to:
decide using the hierarchical option candidates that the AV can trust the environment; and
decide to implement the unique trajectory control action provided by the neural network.

16. The system of claim 13, wherein the neural network comprises:
a hierarchical options network wherein an input state vector sₜ is followed by three fully connected (FC) layers to generate a Q-values matrix Oₜ corresponding to two hierarchical option candidates;
an actions network wherein the input state vector sₜ is followed by four FC layers to produce a continuous action vector aₜ; and
a Q values network that receives the output of a concatenation of the input state vector sₜ followed by an FC layer with the continuous action vector aₜ followed by one FC layer, wherein the Q values network is configured to produce, through four FC layers, a Q-values vector Qₜ which corresponds to the action vector aₜ.

17. The system of claim 16, wherein the intersection maneuver module is configured to choose a discrete behavior action and a unique trajectory control action to perform by:
modelling a choice of actions as a Markov Decision Process (MDP);
learning an optimal policy via the neural network using reinforcement learning; and
implementing the optimal policy to complete the maneuver at the intersection.

18. An autonomous vehicle (AV), comprising:
one or more sensing devices configured to generate vehicle sensor data; and
an intersection maneuver module configured to:
determine, from vehicle sensor data and road geometry data, a plurality of range measurements, each range measurement determined from a unique ray extending from a starting point on the AV to an ending point that is terminated by an obstacle in the path of that ray or a pre-determined maximum distance;
determine, from vehicle sensor data, obstacle velocity data, wherein the obstacle velocity data comprises a velocity of an obstacle determined to be at the ending point of the rays;
determine vehicle state data wherein the vehicle state data includes a velocity of the AV, a distance to a stop line, a distance to a midpoint of an intersection, and a distance to a goal;
determine, based on the plurality of range measurements, the obstacle velocity data and the vehicle state data, a set of discrete behavior actions and a unique trajectory control action associated with each discrete behavior action;
choose a discrete behavior action from the set of discrete behavior actions and the associated unique trajectory control action to perform; and
communicate a message to vehicle controls conveying the chosen unique trajectory control action associated with the discrete behavior action.

19. The autonomous vehicle of claim 18, wherein the intersection maneuver module is configured to determine a plurality of range measurements and determine obstacle velocity data by:
constructing a computer-generated virtual grid around the AV with a center of the virtual grid located at a middle front of the AV;
dividing the virtual grid into a plurality of sub-grids;
assigning an occupied characteristic to a sub-grid when an obstacle or moving object is present in the area represented by the sub-grid;
tracing, through the virtual grid, a plurality of linear rays emitted from the middle front of the AV at a plurality of unique angles that covers a front of the AV, wherein each ray begins at the middle front of the AV and ends when it reaches an occupied sub-grid indicating an obstacle or a pre-determined distance; and
determining, for each ray, the distance of that ray and the velocity of an obstacle at the end-point of that ray.

20. The autonomous vehicle of claim 19, wherein:
the intersection maneuver module is configured to determine a set of discrete behavior actions and a unique trajectory control action associated with each discrete behavior action by:
generating a state vector including the vehicle state data, the distance of each ray, and the velocity of obstacles at the end-points of the rays; and
applying the state vector as an input to a neural network configured to compute the set of discrete behavior actions and the unique trajectory control action associated with each discrete behavior action; and
the neural network comprises:
a hierarchical options network wherein an input state vector sₜ is followed by three fully connected (FC) layers to generate a Q-values matrix Oₜ corresponding to two hierarchical option candidates;
an actions network wherein the input state vector sₜ is followed by four FC layers to produce a continuous action vector aₜ; and
a Q values network that receives the output of a concatenation of the input state vector sₜ followed by an FC layer with the continuous action vector aₜ followed by one FC layer, wherein the Q values network is configured to produce, through four FC layers, a Q-values vector Qₜ which corresponds to the action vector aₜ.
